(19) United States
(12) Patent Application Publication
(10) Pub. No.: US 2007/0003079 A1
(43) Pub. Date: Jan. 4, 2007

(54) The design of electrostatic loudspeakers

(76) Inventors: Charles Cornelus Van Dongen, Melboume (AU); Lindsay Alfred Champion, Melboume (AU); Grover Latham Howard III, Melboume (AU); Robert Neil Mackinlay, Perth (AU)

Correspondence Address: LADAS & PARRY, 26 WEST 61ST STREET, NEW YORK, NY, 10023, US

(21) Appl. No.: 10/573,860

(22) PCT Filed: Jun. 18, 2004
(86) PCT No.: PCT/AU04/00335

§ 371 Date: Mar. 28, 2006

(30) Foreign Application Priority Data
Mar. 18, 2003 (AU) 2003901251

(51) Int. Cl. H04R 3/00

(52) U.S. Cl. 381/116

(57) ABSTRACT

A method of compensating for a reduction in output sound pressure level of an electrostatic loudspeaker, caused by front to back cancellation effects, using a resonant circuit and filter connected between the output of the audio power amplifier (8) and the input of the electrostatic loudspeaker transformer (1). The resonant circuit includes an inductor (3), capacitor (4) and resistor (5), the values of which are chosen so that the shape of the tuned circuit response curve closely mnatches the shape of that part of the loudspeaker response curve that requires compensation. The resonant circuit and filter may be combined with a metal oxide varistor or similar non-linear device to limit over-voltages.

### TECHNICAL FIELD

This Invention relates to electrostatic loudspeakers.

### BACKGROUND ART

Electrostatic loudspeakers are capable of excellent high fidelity sound reproduction, and are generally regarded as being superior In performance to conventional cone type loudspeakers. However, they have some disadvantages, which include inferior bass response due to front to back sound cancellation effects, and propensity to internal high-voltage flashover.

To compensate for the perceived lack of bass response, designers have traditionally relied on increasing panel area which has obvious disadvantages because it results in a physically larger speaker, and does not address the problem of front to back cancellation which occurs in a comparitively narrow frequency range. External compensation by the use of graphic equalisation ahead of the power amplifier has the disadvantage that the required output voltage swing with electrostatic speakers is usually greater than most amplifiers are capable of, resulting in distortion due to clipping at high output levels.

Protection against internal high-voltage flashover has traditionally involved the use of non-linear devices, including spark gaps and metal oxide varistors, to limit the peak voltage applied between the stators. These types of devices generally result in audible distortion of the sound output when voltage limiting occurs.

The invention covered by this application overcomes these disadvantages by providing frequency specific passive electronic compensation for front to back cancellation effects, while simultaneously providing over-voltage protection that limits the peak high-voltage audio signal by compression rather than clipping.

### DISCLOSURE OF THE INVENTION

The invention comprises improvements in the design of electrostatic loudspeakers which overcome known disadvantages of perceived lack of bass response caused by frequency specific reduction in sound pressure level due to front to back cancellation effects, as well as a propensity to internal high voltage flashover.

The invention comprises two distinct, but inter-related, aspects, namely:
A method of compensating for a reduction in output sound pressure level of an electrostatic loudspeaker, caused by front to back cancellation effects.
A method of limiting the peak audio frequency voltages applied to the grids of an electrostatic loudspeaker.

Front to back sound cancellation can occur with most flat panel loudspeakers, including electrostatic loudspeakers, due to physical movement of air between front and back, over the edges of the panel. This results in a reduction in sound pressure level over a specific frequency range, resulting in sound colouration, such as a perceived lack of bass response. The effect typically occurs in the frequency range between 100 Hz and 300 Hz, and reductions in sound pressure level of up to 9 db may occur in this “trough”. Compensation by increasing amplifier output in the frequency range concerned, such as by using a graphic equaliser, is generally not a satisfactory solution to the problem in the case of electrostatics, because it requires an increase in the output voltage swing of the audio amplifier, beyond the range that most amplifiers are capable of.

The first part of the invention comprises electronic circuitry for compensating for the reduction in output sound pressure level of an electrostatic loudspeaker, caused by front to back cancellation effects. This circuitry is connected between the audio amplifier and the primary winding of the electrostatic loudspeaker transformer, and comprises a resonant circuit and filter. The resonant frequency of the circuit is set to correspond with the frequency at which the maximum reduction in sound pressure level occurs.

The circuit is designed so that at frequencies well above or well below the resonant frequency it has no effect on the audio signal transferred from the power amplifier to the speaker. However, at or near the resonant frequency the current flowing from the power amplifier through the primary winding of the speaker transformer builds up over a few cycles to a value that greatly exceeds the value it would have without the tuned circuit present. Hence the audio output of the speaker is increased for frequencies at or near the resonant frequency, which compensates for the front to back cancellation effect.

To operate effectively, an electrostatic loudspeaker requires the application of high audio frequency voltages between the grids and the electrically charged diaphragm. These voltages are generated by a step up audio transformer, which may typically have a ratio of 1:100. The audio voltages add to the D.C. polarising voltage which must be applied between the diaphragm and the centre tap of the driver transformer. Peak voltages of several thousand volts can occur between the grids of an electrostatic loudspeaker, and this can result in electrical flashovers occurring, with resultant damage to the diaphragm. The probability of flashover can be reduced by increasing the size of the air gap between the grids, but this decreases the sensitivity of the loudspeaker, ie. the sound pressure level produced per watt of audio input.

Hence some form of overvoltage protection is required to limit the peak voltage to a safe level. Various forms of protection are known in the art, including spark gaps and non-linear resistors or semi-conducting devices.

Spark gaps have the disadvantage that a visible and audible discharge occurs during operation, and an audible drop in output of the speaker accompanied by distortion, may occur. Other non-linear devices also introduce distortion by clipping of the peaks of the waveform.

The second part of the invention comprises electronic circuitry which limits the peak audio frequency voltage applied to the stators of the speaker by interacting with the resonant circuit referred to above, such that the resonant circuit is detuned momentarily and the audio voltage waveform is thereby compressed.

### BRIEF DESCRIPTION OF DRAWINGS

FIG. 1 shows a resonant circuit and filter connected between the output of the audio power amplifier and the input of the electrostatic loudspeaker transformer.

FIG. 2 shows a non-linear voltage limiting device connected across the output of the electrostatic loudspeaker transformer, which operates in conjunction with the resonant circuit and filter of FIG. 1.

### BEST MODE FOR CARRYING OUT THE INVENTION

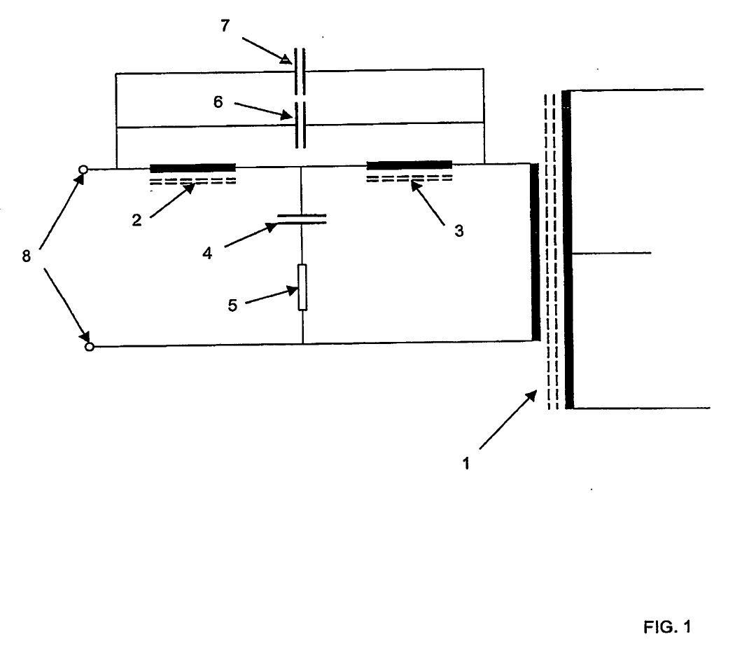

A preferred embodiment of electronic circuitry for compensating for a reduction in output sound pressure level of an electrostatic loudspeaker, caused by front to back cancellation effects, is shown in FIG. 1. This circuitry is connected between the audio amplifier and the primary winding of the electrostatic loudspeaker transformer. The circuit comprises a resonant circuit and filter. The resonant frequency of the circuit is set to correspond with the frequency at which the maximum reduction in sound pressure level occurs.

Input from the audio amplifier is connected to Terminals 8. At frequencies well below the resonant frequency, inductors 2 and 3 have low impedance, and provide a path for the audio signal. Similarly, at these low frequencies, Capacitors 4, 6, and 7 have high impedance, and provide no signal path. The audio input signal passes via Terminals 8 through inductors 2 and 3 to the primary winding of Transformer 1, with very little attenuation. Hence, at these frequencies, the circuit has no effect.

Conversely, at frequencies well above the resonant frequency, Capacitors 6 and 7 have low impedance, and provide a signal path. At these high frequencies, Inductors 2 and 3 have high impedance, and provide no signal path. The audio input signal passes via Terminals 8 through Capacitors 6 and 7 to the primary winding of Transformer 1, with very little attenuation. Hence, at these frequencies, the circuit has no effect.

At or near the resonant frequency, the circuit behaves quite differently. A tuned circuit is formed by Inductor 3, Capacitor 4,and the Inductance of Transformer 1 primary winding. Inductor 2 provides sufficient impedance to decouple the very low output impedance of the audio amplifier from the tuned circuit. Resistor 5 determines the Q of the tuned circuit. At or near the resonant frequency, the current flowing through Transformer 1 primary winding builds up over a few cycles to a value that greatly exceeds the value it would have without the tuned circuit present. Hence the audio output of the speaker is increased for frequencies at or near the resonant frequency, which compensates for the front to back cancellation effect. The values of Inductor 3, Capacitor 4, and Resistor 5 are chosen so that the shape of the tuned circuit response curve closely matches the shape of that part of the speaker response curve that requires compensation. It is possible to select values of Inductor 3, Capacitor 4, and Resistor 5 such that there is no reduction in sound pressure level of the loudspeaker in the frequency band where front to back cancellation is occurring.

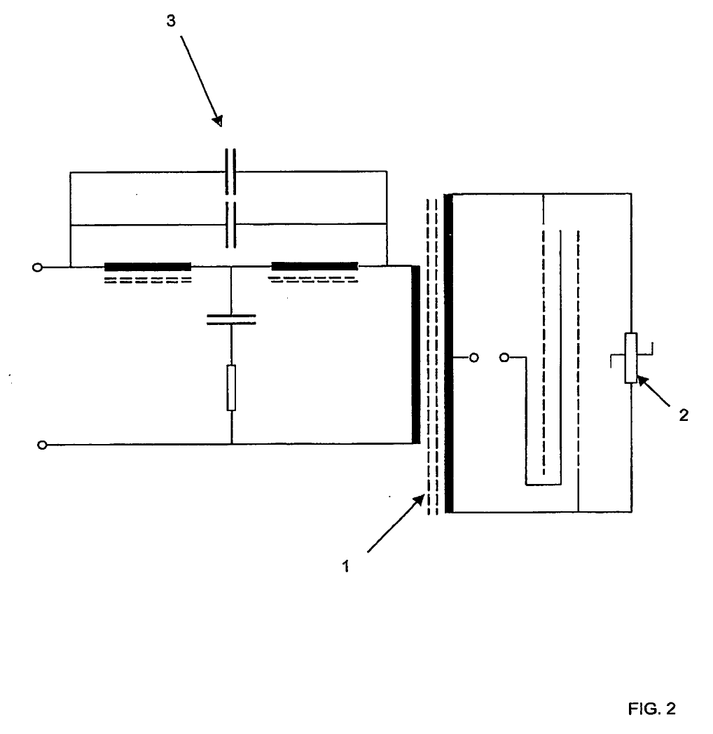

A preferred embodiment for limiting the peak voltage between the grids is shown in FIG. 2. A Metal Oxide Varistor 2 (MOV) or similar non-linear device is connected across the high voltage winding of Transformer 1. Several MOV's may be connected in series to achieve the required voltage rating. The protective MOV operates in conjunction with Resonant Circuit and Filter 3 (as described in Item 2. above), to limit overvoltages without introducing any appreciable distortion.

As discussed above, Resonant Circuit and Filter 3 increases the current flowing in the primary of Transformer 1 at or near the resonant frequency to compensate for front to back cancellation effects. Hence the output voltage of Transformer 1 is likely to be highest at these frequencies, and may be two to three times the voltages that occur at other frequencies. The cut-in voltage of the MOV's is typically chosen to be about half of the estimated maximum voltage that can occur. As the MOV's begin to conduct small amounts of resistive current flow at the peaks of the voltage waveform. This causes an increase in the resistive component of the impedance reflected to the primary of Transformer 1. As this impedance forms part of the tuned circuit (as described above) the circuit becomes more heavily damped and therefore the current in Transformer 1 primary is reduced. This in turn reduces the output voltage of Transformer 1. The whole voltage waveform is effectively compressed by the damping effect, and is not clipped as would occur if the resonant compensating circuit were not present. Because clipping does not occur, there is no audible distortion when the overvoltage protection circuit operates.

### INDUSTRIAL APPLICABILITY

This Invention is applicable to all electrostatic loudspeakers intended for use in domestic applications such as hi-fi and home cinema and some commercial applications.

1. A method of compensating for a reduction in sound pressure level of an electrostatic loudspeaker caused by front to back cancellation effects, utilising a resonant circuit and filter in the primary circuit of the electrostatic loudspeaker transformer to boost the output of the loudspeaker in the frequency band in which cancellation occurs.

2. A method of limiting the peak voltage between the stators of an electrostatic loudspeaker incorporating the resonant circuit and filter of claim 1, by utilising a metal oxide varistor or other non-linear device connected between the stators to damp the resonant circuit and thereby compress the voltage waveform when conduction through the metal oxide varistor or other non-linear device occurs.
